(19) United States
(12) Patent Application Publication
(10) Pub. No.: US 2013/0169087 A1
(43) Pub. Date: Jul. 4, 2013

(54) MOTOR-DRIVEN DEVICE FOR ACTUATING A MOVABLE PANEL OF A MOTOR VEHICLE

(71) Applicant: Frank Kummer, Augsburg (DE)

(72) Inventor: Frank Kummer, Augsburg (DE)

(73) Assignee: VALEO SICHERHEITSSYSTEME GMBH, Erdweg (DE)

(21) Appl. No.: 13/810,273

(22) PCT Filed: Jul. 14, 2011
(86) PCT No.: PCT/EP2011/062065

§ 371 Date: Mar. 11, 2013

(30) Foreign Application Priority Data
Jul. 16, 2010 (EP) 10169865.2

(51) Int. Cl. H02K 7/108; F16D 13/12

(52) U.S. Cl. CPC H02K 7/108; F16D 13/12
USPC 310/76

(57) ABSTRACT

The invention relates to a motor-driven device for actuating a movable panel (1) of a motor vehicle, including: a drive unit (3); a transmission element (5) which is to be set into motion by the motor unit (3); a braking module (7) for the transmission element (5), characterized in that the braking module (7) is connected to the transmission element (5) by a clutch module (9) positioned between the transmission element (5) and the drive unit (3), and comprising a wound spring (35) in friction contact with a brake shaft (23) connected to the braking module (7), as well as two coupling elements (25, 27) that are mutually engaged with a functional clearance therebetween, the relative change in position of said two coupling elements (25, 27) enabling the ends (37, 38) of said wound spring (35) to be controlled so as to switch the ends between an engaged position and a disengaged position of the braking module (7), wherein the two coupling elements (25, 27) are a drive element and a driven element, respectively.

The invention relates to a motor-driven device for actuating a movable panel of a motor vehicle, such as a door or a trunk lid.

The use of an electric motor is already familiar in order to render automatic or to assist the opening or closing of a movable panel of a motor vehicle. The motor actuates a transmission mechanism which sets the movable panel into motion. Present between the motor and the transmission mechanism are different elements intended to permit the sequence of opening the movable panel to be controlled.

These elements generally comprise at least one clutch and one braking module. The clutch permits the coupling or otherwise of the braking module, for example when the movable panel is actuated manually or by its own weight. The braking module operates in particular when the movable panel is required to remain in a fixed position, generally not being an end position. In the case of a trunk lid, for example, the braking module is required to act against the gravitational force acting on the movable panel in order to prevent it from falling back.

Given that the brake and the motor have antagonistic effects, the braking module must not be coupled to the transmission mechanism when the motor is running. The use of electromechanical actuators which control the clutch so that the brake is disengaged when the motor is running is previously disclosed in order to perform this function.

These actuators are relatively expensive, however, and they are subject to the failures that are inherent in electronic devices. These actuators become inoperative, furthermore, if the vehicle battery is exhausted, at the risk of leaving the braking module in the uncoupled or coupled state.

In order to counter the aforementioned shortcomings, the invention proposes a motor-driven device for actuating a movable panel of a motor vehicle, including:
a motor unit,
a transmission element which is to be set into motion by the motor unit,
a braking module for the transmission element,
   characterized in that the braking module is connected to the transmission element by a clutch module positioned between the transmission element and the motor unit, and comprising a wound spring in friction contact with a brake shaft connected to the braking module, as well as two coupling elements that are mutually engaged with a functional clearance between them, the relative change in position of said two coupling elements enabling the ends of said wound spring to be controlled so as to switch the ends between an engaged position and a disengaged position of the braking module, depending on which of the two coupling elements is driving and driven, respectively.

A motor-driven device for actuating a movable panel of a motor vehicle by selectively coupling a braking module to the transmission, while being entirely mechanical, is obtained in this way. There is thus no need for any electrical supply and control. Therefore, the cost of and the shortcomings in the controlled electronic components are avoided.

The motor-driven device for actuating a movable panel of a motor vehicle may, in addition, exhibit one or a plurality of the following characteristics, either singly or in combination.

The coupling elements are in positive-locked engagement with one another.

One of the coupling elements comprises an axial slot, and the other a finger of matching shape and of smaller transversal extent in order to permit functional clearance to be obtained, and the ends of the wound spring are arranged to either side of the finger, in the axial slot.

The wound spring surrounds the brake shaft.

The wound spring is arranged inside the brake shaft.

The brake shaft comprises a friction material covering.

The friction material is carbon, calcareous tufa or molybdenum.

The transmission element comprises an endless screw.

The clutch module comprises a mechanical transmission coupling connected to an output shaft from the motor unit.

The mechanical transmission coupling comprises an Oldham coupling.

The mechanical transmission coupling comprises a universal coupling.

The braking module comprises a magnet connected to the brake shaft and a magnetic hysteresis material arranged around the magnet.

The braking module comprises friction braking means.

Other characteristics and advantages will become apparent from reading the following description of the figures, in which:

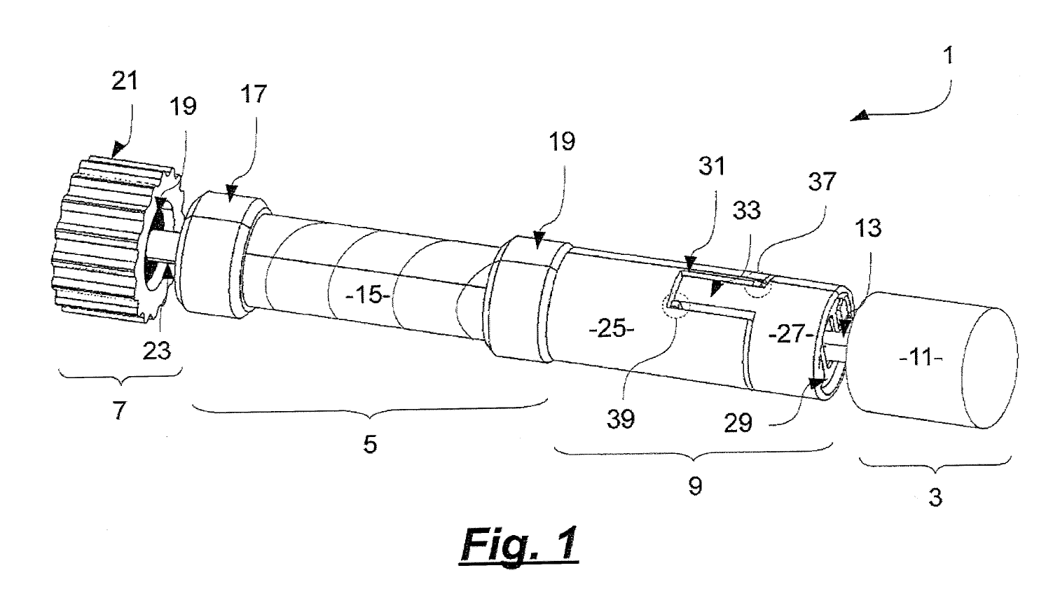

FIG. 1 is a simplified perspective view of an embodiment of a device according to the invention;

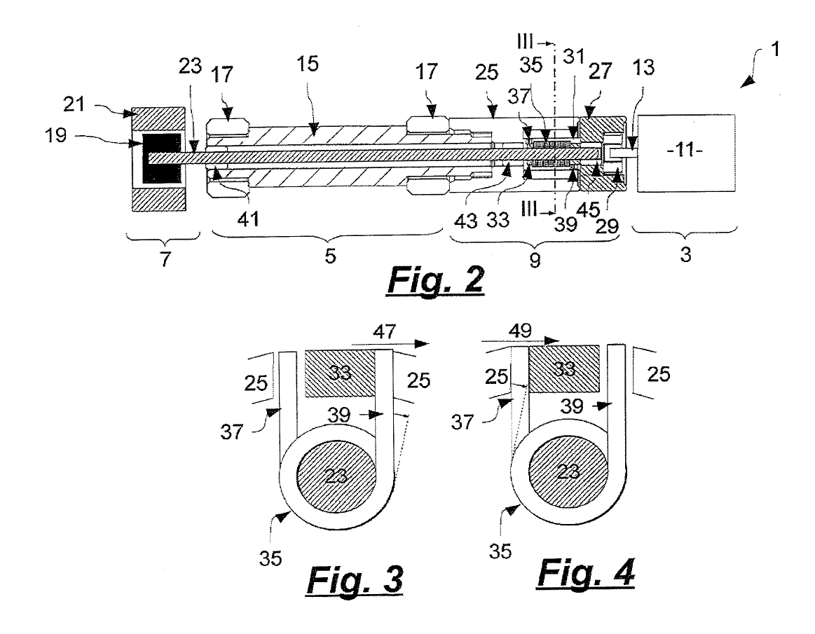

FIG. 2 is a simplified view in longitudinal section of the embodiment of the device in FIG. 1;

FIGS. 3 and 4 are frontal sectional views according to line in FIG. 2, at the level of the wound spring of the device on FIG. 1; in FIG. 3 when a torque originating from the motor unit is transmitted, and in FIG. 4 when a torque originating from the transmission element is transmitted;

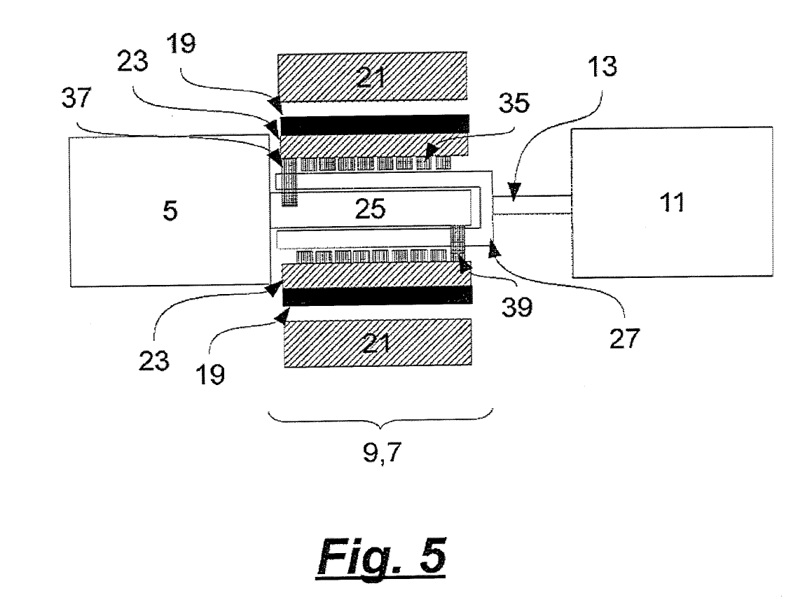

FIG. 5 is a schematic sectional view of an alternative embodiment of the device;

The same references relate to the same elements in all the figures.

The object of the invention is a motor-driven device 1 for actuating a movable panel of a motor vehicle. Such devices are installed in a motor vehicle at the level of its movable panels, doors, trunk lid and hood.

Such a device 1 is illustrated in FIG. 1. It comprises on the one hand a motor unit 3 supplied, for example, with the onboard electricity of the vehicle and capable of being controlled by the onboard electronics.

This device comprises a transmission element 5 intended to be set into motion by the motor unit 3, and the setting in rotation of which corresponds, depending on the direction of said rotation, to a closing or opening movement of a movable panel (not illustrated here).

The device 1 also comprises a braking module 7 intended to brake the transmission element 5, in particular when the movable panel is in an intermediate position between the open position and the closed position, and when the motor unit 3 is not being supplied with electrical power.

Arranged between the motor unit 3 and the transmission element 5 is a clutch module 9 connected to said motor unit 3, to the transmission element 5 and to the braking module 7.

The motor unit 3 comprises in particular a motor 11 and an output shaft 13. According to one embodiment (not illustrated here), the motor unit 3 can also comprise different power adjustment elements between the motor 11 and the output shaft 13 for the purpose of adjusting the torque delivered by the motor 11 to the needs of the device 1 at the level of the output shaft 13. The power adjustment elements may comprise, for example, one or a plurality of epicyclic reduction gears. When the motor 11 is supplied with current, it delivers a torque that is transmitted to the output shaft 13.

The transmission element 5 comprises an endless screw 15 supported on bearings 17 and having a hollowed-out core, which imparts a substantially tubular form to it.

The braking module 7 comprises a magnet 19 arranged inside a magnetic hysteresis material 21 and connected to a brake shaft 23, the brake shaft 23 passing through the transmission element 5 (see FIG. 2 in particular). In this way, when the brake shaft 23 is caused to rotate, the magnet 19 is also caused to rotate inside the magnetic hysteresis material 21, resulting in the generation of a braking torque acting in the opposite direction to the rotation of the brake shaft 23.

An alternative embodiment (not illustrated here) of the braking module 7 proposes the use of friction braking means, for example a brake disc and an associated friction block.

The clutch module 9 comprises two coupling elements 25, 27 in the form of coupling sleeves. One 25 of these is disposed in a fixed rotational connection with the transmission element 5, and the other 27 is disposed in a fixed rotational connection with the output shaft 13 of the motor unit 13 via a mechanical transmission coupling 29 consisting of an Oldham coupling. One embodiment proposes that the mechanical transmission coupling 29 additionally or alternatively comprises a universal coupling to permit the transmission of the torque delivered by the motor unit 3 to the coupling sleeve 27 that is connected to it.

The two coupling sleeves 25, 27 are in positive-locked engagement with one another.

The coupling sleeve 25 connected to the transmission element 5 is provided with an axial slot 31 of rectangular form. Engaged in this axial slot 31 is a finger 33 of corresponding rectangular form and of smaller width, such that a functional clearance is present between the two coupling sleeves 25, 27 as they rotate.

The clutch module additionally comprises a wound spring 35 (see FIG. 2), of which only two end limbs 37, 39 are visible in FIG. 1. These two end limbs 37, 39 are arranged to either side of the finger 33 in the axial groove 31.

FIG. 2 is a view of the device 1 in longitudinal section.

It can be appreciated from this figure that the brake shaft passes through the transmission element 5 as well as the two coupling shafts 25, 27 as far as the mechanical transmission coupling 29. The brake shaft 23 is supported by three bearings 41, 43, 45 arranged respectively at the level of the transmission element 5, the first coupling sleeve 25 and the second coupling sleeve 27.

The wound spring 35 surrounds the brake shaft 23 and is in friction contact with it in the absence of any effect on its end limbs 37, 39.

The end limbs 37, 39 are able to switch between a separated position and a constricted position. In the first position, the separation of the end limbs 37, 39 brings about an increase in the diameter of at least several turns of the wound spring 35, which corresponds to a disengaged state of the brake shaft 23. In the second position, the constriction of the end limbs 37, 39 accentuates the friction of the spring on the brake shaft 23, which corresponds to an engaged state of the brake shaft 23.

FIGS. 3 and 4 illustrate a cross-sectional view at the level of the wound spring 35 of the device 1 according to line in FIG. 2. The said wound spring 35 can be seen here to surround the brake shaft 23, its two end limbs 37, 39 being arranged between the internal edge of the axial slot 31 of the first coupling sleeve 25 and the finger 33 of the second axial sleeve 27.

In FIG. 3, the sleeve 27 connected to the motor unit 3 is driving, and the sleeve 25 connected to the transmission element 5 is driven. This is the case that is encountered when the motor 11 is supplied with current, and it causes the transmission element 5 to be set into motion in order to open or close the movable panel automatically.

The finger 33 is driven and transmits the motive force to the end limb 39 of the wound spring 35 in a direction which separates the limbs 37, 39, as indicated by the arrow 47. The turns of the spring then release the brake shaft 23, which is now disengaged.

In FIG. 4, the sleeve 25 connected to the transmission element 5 is driving, and the sleeve 27 connected to the motor unit 3 is driven. This is the case that is encountered when the motor 11 is not supplied with current and when the transmission element 5 is set into motion by the movable panel, for example under the effect of the weight of said movable panel.

The coupling sleeve 25 carrying the axial slot 31 is driven and transmits the motive force to the end limb 37 of the wound spring 35 in a direction which constricts the limbs 37, 39, as indicated by the arrow 49. The turns of the spring then constrict around the brake shaft 23, which is now engaged.

An alternative embodiment, exhibiting a different architecture, is illustrated schematically in FIG. 5 in a longitudinal sectional view. In this architecture, the braking module 7 surrounds the clutch module 9.

The coupling elements 25, 27 are in engagement with one another at the center, the wound spring 35 being wound around said elements 25, 27, and its end limbs 37, 39 being pointed towards the interior in order to interact with the coupling elements 25, 27.

The brake shaft 23 is realized in the form of a tube surrounding all of the preceding elements: coupling elements 25, 27 and wound spring 35. The magnet 19 is also in the form of a tube positioned around the brake shaft 23 and disposed in a fixed rotational connection with it, with the magnetic hysteresis material 21 surrounding the whole and itself possessing a substantially tubular form.

In this configuration, the brake shaft 13 is engaged when the end limbs 37, 39 of the wound spring 35 are separated. Conversely, the brake shaft 13 is disengaged when the end limbs 37, 39 are constricted.

This architecture has the advantage of being axially more compact, whereas the architecture described previously permits a module to be obtained that is radially more compact.

In order to control the friction of the wound spring 35 on the brake shaft 13, it is proposed to apply a coating of friction material to the brake shaft, and at least on the portion surrounding the wound spring.

This friction material also serves the function of slowing down the wear on the brake shaft 13 during use. This material may be in particular carbon, calcareous tufa or molybdenum.

The invention thus permits a motor-driven device 1 for actuating a movable panel of a motor vehicle to be obtained, which permits the selective engagement of a braking module 7 with a transmission element 5, depending on whether or not the said transmission element 5 is set into motion by a motor unit 3, by means of a module that is entirely mechanical and of compact architecture.

As a result, the invention makes it possible to avoid wear in the regulated or controlled electronic elements, which represents both a potential cost and a potential source of failures.

1. A motor-driven device for actuating a movable panel of a motor vehicle, comprising:
a motor unit;
a transmission element which is set into motion by the motor unit;
a braking module for the transmission element;
wherein the braking module is connected to the transmission element by a clutch module positioned between the transmission element and the motor unit;
a wound spring in friction contact with a brake shaft connected to the braking module; and
two coupling elements that are mutually engaged with a functional clearance between them, the relative change in position of said two coupling elements enabling the ends of said wound spring to be controlled so as to switch the ends between an engaged position and a disengaged position of the braking module, depending on which of the two coupling elements is driving and driven, respectively.

2. The device as claimed in claim 1, wherein the coupling elements are in positive-locked engagement with one another.

3. The device as claimed in claim 1, wherein one of the two coupling elements comprises an axial slot, and the other of the two coupling elements comprises a finger of matching shape and of smaller transversal extent in order to permit functional clearance to be obtained, wherein the ends of the wound spring are arranged to either side of the finger, in the axial slot.

4. The device as claimed in claim 1, wherein the wound spring surrounds the brake shaft.

5. The device as claimed in claim 1, wherein the wound spring is arranged inside the brake shaft.

6. The device as claimed in claim 1, wherein the brake shaft comprises a friction material covering.

7. The device as claimed in claim 6, wherein the friction material is one selected from the group consisting of carbon, calcareous tufa or molybdenum.

8. The device as claimed in claim 1, wherein the transmission element comprises an endless screw.

9. The device as claimed in claim 1, wherein the clutch module comprises a mechanical transmission coupling connected to an output shaft from the motor unit.

10. The device as claimed in claim 9, wherein the mechanical transmission coupling comprises an Oldham coupling.

11. The device as claimed in claim 9, wherein the mechanical transmission coupling comprises a universal coupling.

12. The device as claimed in claim 1, wherein the braking module comprises a magnet connected to the brake shaft and a magnetic hysteresis material arranged around the magnet.

13. The device as claimed in claim 1, wherein the braking module comprises friction braking means.
